(19) United States
(12) Patent Application Publication
(10) Pub. No.: US 2023/0027337 A1
(43) Pub. Date: Jan. 26, 2023

(54) POWER TOOL

(71) Applicant: MAKITA CORPORATION, Anjo-shi (JP)

(72) Inventors: Hiroki IKUTA, Anjo-shi (JP); Yosuke NAOI, Anjo-shi (JP)

(73) Assignee: MAKITA CORPORATION, Anjo-shi (JP)

(21) Appl. No.: 17/856,692

(22) Filed: Jul. 1, 2022

(30) Foreign Application Priority Data
Jul. 21, 2021 (JP) 2021-121030

(51) Int. Cl. F16H 3/00; F16H 57/08; A01G 3/053

(52) U.S. Cl. CPC F16H 3/005; F16H 57/08; A01G 3/053; A01G 2003/0461

(57) ABSTRACT

A power tool includes a motor, a speed reducer and a speed-reducing-ratio change mechanism. The speed reducer includes planetary gear mechanisms arranged in multiple stages. The speed-reducing-ratio change mechanism is configured to change a speed reducing ratio of the speed reducer in response to a change of a rotating direction of a motor shaft. At least two stages of the planetary gear mechanisms are configured such that an internal gear in each stage selectively functions as a fixed element. The speed-reducing-ratio change mechanism includes a one-way clutch and a lock mechanism configured to non-rotatably lock the internal gears of the at least two stages when the one-way clutch does not transmit rotation, and to rotate the internal gears of the at least two stages when the one-way clutch transmits rotation. The at least two stages include a speed-increasing planetary gear mechanism and a speed-reducing planetary gear mechanism.

### CROSS-REFERENCE TO RELATED APPLICATION

The present application claims priority to Japanese patent application No. 2021-121030 filed on Jul. 21, 2021, the contents of which are hereby fully incorporated herein by reference.

### TECHNICAL FIELD

The present disclosure relates to a power tool. More specifically, the present disclosure relates to a power tool having a speed reducer of which a speed reducing ratio is changeable.

### BACKGROUND

Some known power tools have a motor that is rotatable in two directions (a first direction and a second direction) and configured to perform different actions according to whether the motor rotates in the first direction or in the second direction. For example, Japanese Unexamined Patent Application Publication No. 2005-269972 discloses a hedge trimmer having a planetary gear transmission mechanism. The speed reducing ratio of the planetary gear transmission mechanism is changed according to whether the motor rotates in the first direction or in the second direction.

### SUMMARY

In the above-described planetary gear transmission mechanism, when an internal gear is switched between a fixed (stationary) state and a freely-rotatable state according to the rotating direction of the motor, the speed reducing ratio is changed. In this transmission mechanism, however, the change of the speed reducing ratio and thus a difference between output speeds before and after the change tend to be excessively large.

Accordingly, it is an object of the present disclosure to provide improvement in a power tool having a speed reducer of which a speed reducing ratio is changeable.

A non-limiting aspect of the present disclosure herein provides a power tool that includes a motor, a speed reducer and a speed-reducing-ratio change mechanism. The motor has a motor shaft that is rotatable in two directions that are opposite to each other. The speed reducer is operably coupled to the motor shaft. The speed reducer includes planetary gear mechanisms arranged in multiple stages. A planetary gear mechanism may also be called a planetary gear train, epicyclic gearing, an epicyclic gear train, etc. The speed-reducing-ratio change mechanism is configured to change a speed reducing ratio of the speed reducer in response to a change of the rotating direction of the motor shaft.

At least two stages of the planetary gear mechanisms are configured such that an internal gear in each stage selectively functions as a fixed (stationary) element. The speed-reducing-ratio change mechanism includes a one-way clutch and a lock mechanism. The one-way clutch is disposed in a torque transmission path and configured to transmit rotation only when the motor shaft rotates in specific one of the two directions. The lock mechanism is operably coupled to the one-way clutch and to the internal gears of the at least two stages of the planetary gear mechanisms. The lock mechanism is configured to non-rotatably lock the internal gears of the at least two stages when the one-way clutch does not transmit rotation. The lock mechanism is also configured to rotate the internal gears of the at least two stages when the one-way clutch transmits rotation. The at least two stages of the planetary gear mechanisms include a speed-increasing planetary gear mechanism configured to function as a speed-increasing mechanism, and a speed-reducing planetary gear mechanism configured to function as a speed-reducing mechanism.

The power tool of this aspect includes the speed reducer, which includes the planetary gear mechanisms arranged in multiple stages, and the speed-reducing-ratio change mechanism. The speed-reducing-ratio change mechanism is configured to switch a state of the internal gears of the at least two planetary gear mechanisms between a non-rotatable state (locked state) and a rotatable state, in response to a change of the rotating direction of the motor shaft. Each of the internal gears effectively functions as a fixed element in the locked state. On the other hand, when rotated, the internal gear can no longer function as the fixed element. Thus, the number of the stages of the planetary gear mechanisms that effectively function in the speed reducer is reduced by at least two, and thus the speed reducing ratio (transmission ratio) of the speed reducer is changed. In this manner, the power tool of this aspect can selectively perform either one of two actions that are different in the required output speed and output torque simply in response to the change of the rotating direction of the motor without need for controlling the rotating speed of the motor.

Generally, when an internal gear serves as a fixed element in a planetary gear mechanism structured as a speed-reducing mechanism, the planetary gear mechanism has a relatively large speed reducing ratio due to structural constraints of the gears. Therefore, in a known speed reducer in which the speed reducing ratio is changed by enabling or disabling the function of at least one of such planetary gear mechanisms, the change of the speed reducing ratio tends to become large. On the contrary, according to this aspect, the function of the at least two stages of planetary gear mechanisms, which includes the speed-increasing planetary gear mechanism and the speed-reducing planetary gear mechanisms, are enabled (made effective) or disabled (made ineffective). Owing to this structure, the speed increasing ratio or the speed reducing ratio of an entirety of the at least two stages of planetary gear mechanisms can be flexibly set by properly combining the speed increasing ratio, which is smaller than one (<1), of the speed-increasing planetary gear mechanism and the speed reducing ratio, which is larger than one (>1), of the speed-reducing planetary gear mechanism. As a result, the change of the speed reducing ratio of an entirety of the speed reducer and thus the change of the output speed can be made smaller than that in the known power tool. Thus, the power tool of this aspect can selectively perform either one of two actions between which a difference in the output speed is relatively small, in response to a change of the rotating direction of the motor.

Another non-limiting aspect of the present disclosure herein provides a power tool that includes a motor, a speed reducer and a speed-reducing-ratio change mechanism. The motor has a motor shaft that is rotatable in two directions that are opposite to each other. The speed reducer is operably coupled to the motor shaft. The speed reducer includes a planetary gear mechanism. The speed-reducing-ratio change mechanism is configured to change a speed reducing ratio of the speed reducer in response to a change of the rotating direction of the motor shaft. The planetary gear mechanism is configured such that a sun gear of the planetary gear mechanism selectively functions as a fixed element, and an internal gear of the planetary gear mechanism functions as an input element.

The speed-reducing-ratio change mechanism includes a one-way clutch and a lock mechanism. The one-way clutch is disposed in a torque transmission path, and configured to transmit rotation only when the motor shaft rotates in specific one of the two directions. The lock mechanism is operably coupled to the one-way clutch and to the sun gear. The lock mechanism is configured to non-rotatably lock the sun gear when the one-way clutch does not transmit rotation, and to rotate the sun gear when the one-way clutch transmits rotation.

The power tool of this aspect includes the speed reducer, which includes the planetary gear mechanism, and the speed-reducing-ratio change mechanism. The speed-reducing-ratio change mechanism is configured to switch a state of the sun gear of the planetary gear mechanism between a non-rotatable state (locked state) and a rotatable state, in response to a change of the rotating direction of the motor shaft. The sun gear effectively functions as a fixed element in the locked state. On the other hand, when rotated, the sun gear can no longer function as the fixed element. Thus, the number of the stages of the planetary gear mechanism that effectively function in the speed reducer is reduced by one, and thus the speed reducing ratio (transmission ratio) of the speed reducer is changed. In this manner, the power tool of this aspect can selectively perform either one of two actions that are different in the required output speed and output torque simply in response to the change of the rotating direction of the motor without need for controlling the rotating speed of the motor.

Further, in the planetary gear mechanism of this aspect, in which the sun gear selectively functions as the fixed element, the speed reducing ratio is smaller than that in a speed reducer in which an internal gear functions as a fixed element. The change of the speed reducing ratio, which is achieved by enabling or disabling the function of the planetary gear mechanism, can also be made smaller than that in a speed reducer in which an internal gear functions as a fixed element. Thus, the power tool of this aspect can selectively perform either one of two actions between which a difference in the output speed is relatively small, in response to a change of the rotating direction of the motor.

### BRIEF DESCRIPTION OF THE DRAWINGS

FIG. 1 is an overall perspective view of a hedge trimmer according to a first embodiment.

FIG. 2 is a sectional view of the hedge trimmer.

FIG. 3 is a partial, enlarged view of FIG. 2 (not showing a body housing and a connecting rod).

FIG. 4 is a sectional view taken along line IV-IV in FIG. 3.

FIG. 5 is a perspective, exploded view showing a speed reducer and a speed-reducing-ratio change mechanism.

FIG. 6 is an explanatory view for illustrating an operation principle of a lock mechanism, schematically showing a cross-section of the lock mechanism in a locked state.

FIG. 7 is an explanatory view for illustrating the operation principle of the lock mechanism, schematically showing a cross-section of the lock mechanism in an unlocked state.

FIG. 8 is a partial, enlarged view of a hedge trimmer according to a second embodiment (not showing a body housing and a connecting rod).

FIG. 9 is a perspective, exploded view showing a speed reducer and a speed-reducing-ratio change mechanism.

### DETAILED DESCRIPTION OF THE EMBODIMENTS

In one non-limiting embodiment according to the present disclosure, the speed-increasing planetary gear mechanism may be arranged in a former stage (on an input side) of the speed-reducing planetary gear mechanism. With this structure, torque that is transmitted from the speed-increasing planetary gear mechanism to the speed-reducing planetary gear mechanism can be made smaller than torque that is transmitted from a speed-reducing planetary gear mechanism to a speed-increasing planetary gear mechanism in a structure in which the speed-reducing planetary gear mechanism is arranged in the former (previous) stage (on the input side) of the speed-increasing planetary gear mechanism. Therefore, the strength required for the gears can be made smaller than that in the structure in which the speed-reducing planetary gear mechanism is arranged in the former stage of the speed-increasing planetary gear mechanism, and thus the gears can be made compact.

In addition or in the alternative to the preceding embodiment, a sun gear of the speed-increasing planetary gear mechanism that functions as an output element of the speed reducer and a sun gear of the speed-reducing planetary gear mechanism that functions as an input element of the speed reducer may form a single member in the speed reducer. With this structure, the speed reducer can be simplified in structure and thus assembling of the speed reducer can be facilitated.

In addition or in the alternative to the preceding embodiments, the speed reducer may be configured to operate in a high-speed and low-torque mode when the lock mechanism non-rotatably locks the internal gears of the at least two stages, and to operate in a low-speed and high-torque mode when the lock mechanism rotates the internal gears of the at least two stages. In other words, the speed reducer may be configured to operate in the high-speed and low-torque mode when the planetary gear mechanisms of the at least two stages effectively function, and to operate in the low-speed and high-torque mode when the planetary gear mechanisms of the at least two stages do not function. Thus, an entirety of the planetary gear mechanisms of the at least two stages may be configured to function as a speed-increasing mechanism. With this structure, torque can be effectively increased by rotation of the internal gears in the low-speed and high-torque mode.

In addition or in the alternative to the preceding embodiments, the power tool may further include a reduction gear that is disposed between the motor shaft and the internal gear of the planetary gear mechanism in the torque transmission path. With this structure, speed reduction can be performed prior to the speed reduction by the planetary gear mechanism.

In addition or in the alternative to the preceding embodiments, the speed reducer may include only one (a single) stage of the planetary gear mechanism. With this structure, the compact speed reducer can be achieved.

In addition or in the alternative to the preceding embodiments, the internal gear of the planetary gear mechanism may be rotatably supported by a first bearing. With this structure, rotation of the internal gear can be stabilized.

In addition or in the alternative to the preceding embodiments, the one-way clutch may include a clutch member and second bearings disposed on opposite sides of the clutch member in an axial direction of the one-way clutch. With this structure, the second bearings can secure smooth rotation of a rotatable member that rotates relative to the one-way clutch when the one-way clutch does not transmit rotation (idles).

In addition or in the alternative to the preceding embodiments, the speed reducing ratio of the speed reducer when the motor shaft rotates in one of the two directions may be less than 2.5 times the speed reducing ratio when the motor shaft rotates in the other of the two directions. With this structure, the power tool can selectively perform either one of the two actions between which a difference in the output speed is relatively small, in response to a change of the rotating direction of the motor.

In addition or in the alternative to the preceding embodiments, the power tool may be a cutting tool that includes a body to which a first blade and a second blade are removably attachable. The cutting tool may be configured to linearly reciprocate the first blade and the second blades relative to each other and thereby cut an object in a forward stroke, in which the first blade moves forward relative to the second blade, and also in a backward stroke in which the first blade moves backward relative to the second blade. With this structure, the cutting tool can selectively perform either one of the two actions that are different in the output speed and cutting force, in response to a change of the rotating direction of the motor according to the kind of the object.

Non-limiting, representative embodiments of the present disclosure are now described in detail with reference to the drawings.

### First Embodiment

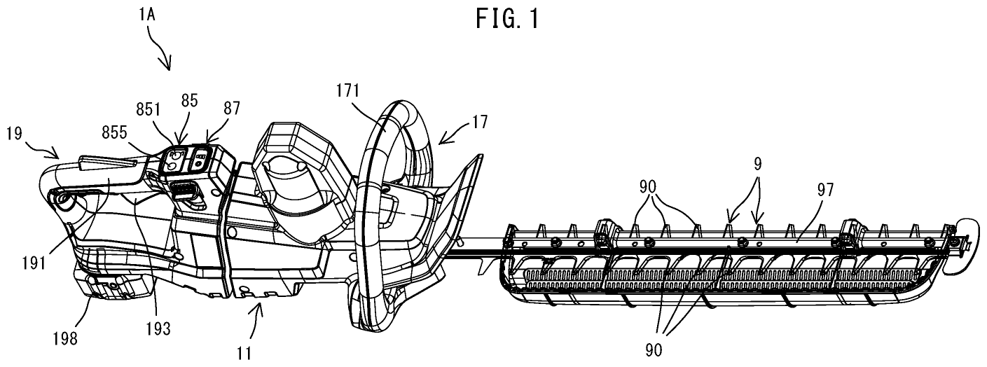

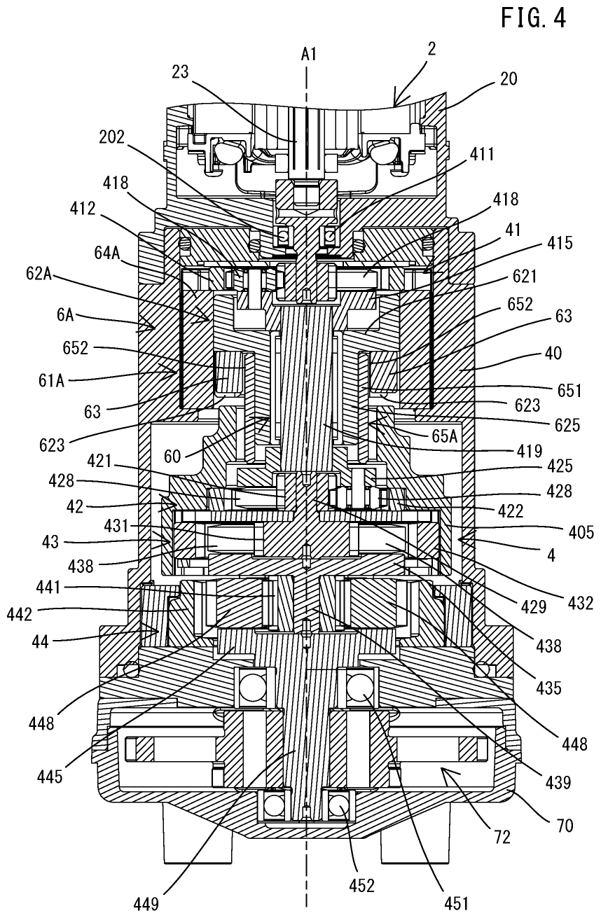

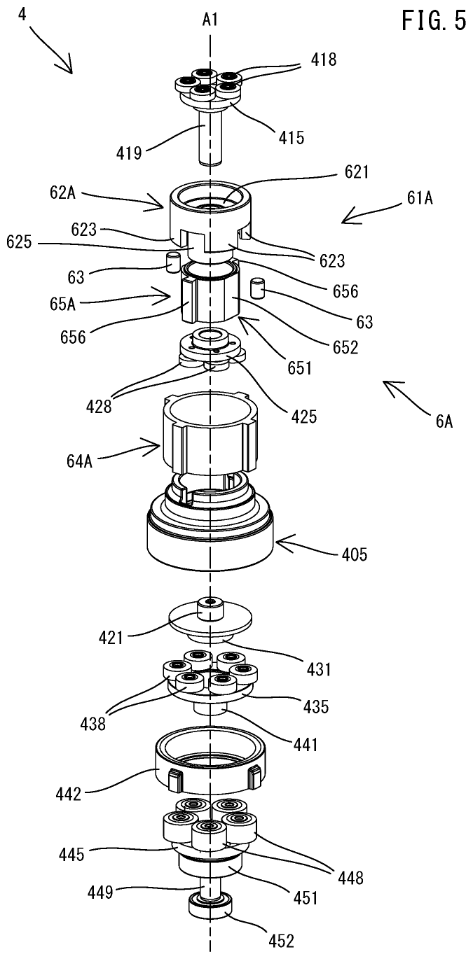

A hedge trimmer 1A according to a first embodiment of the present disclosure is now described with reference to FIGS. 1 to 7. The hedge trimmer 1A is an example of a power tool that is mainly used for trimming or pruning hedges and trees. The hedge trimmer 1A is configured to cut an object (typically, branches and leaves of trees) by linearly reciprocating two removably mounted blades 9 relative to each other.

The general structure of the hedge trimmer 1A is now described.

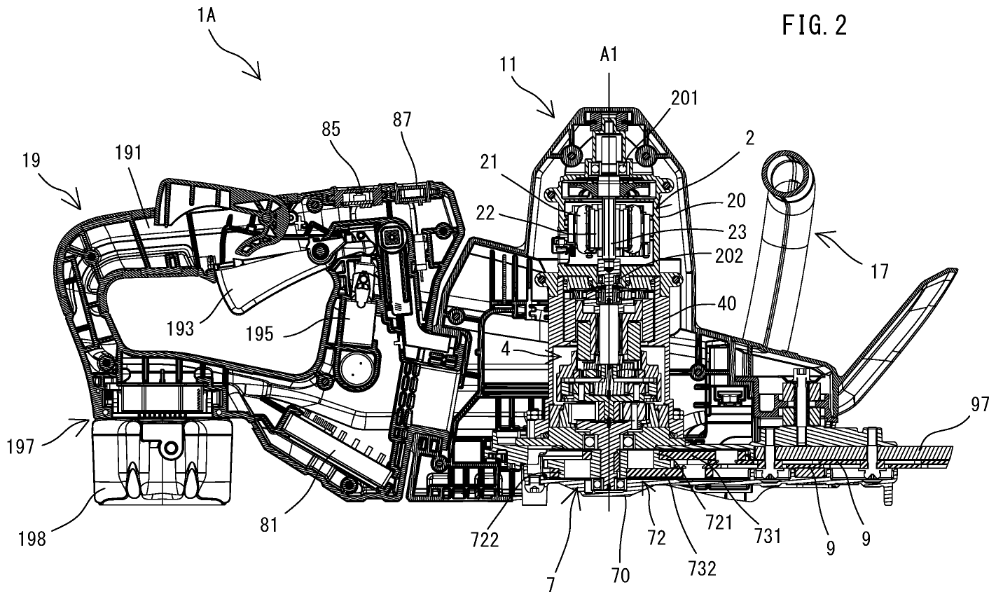

As shown in FIGS. 1 and 2, an outer shell of the hedge trimmer 1A is mainly formed by a body housing 11 and two handles 17, 19 connected to the body housing 11. The body housing 11 houses a motor 2, a speed reducer 4 and a motion converting mechanism 7. Each of the elongate plate-like blades 9 is operably coupled to the motion converting mechanism 7. The blades 9 protrude from one end of the body housing 11 and extends linearly in a direction that is orthogonal to a prescribed axis A1. The handle 17 is connected to one of two opposite end portions of the body housing 11 that is closer to the blade 9, and the handle 19 is connected to the other end portion of the body housing 11 that is farther from the blade 9. The handle 19 has a switch lever (also referred to as a trigger) 193 configured to be manually depressed by a user. When the switch lever 193 is depressed, the motor 2 is energized and the blades 9 are driven for relative reciprocating motion in their longitudinal direction.

In the following description, for the sake of convenience, an extension direction of a longitudinal axis of the blade 9 (or a longitudinal direction of the body housing 11) is defined as a front-rear direction of the hedge trimmer 1A. In the front-rear direction, the direction from the body housing 11 toward a distal end (free end) of the blade 9 is defined as a forward direction, and the opposite direction (the direction from the distal end of the blade 9 toward the body housing 11) is defined as a rearward direction. Accordingly, the handle 17, which is closer to the blade 9, is hereinafter also referred to as a front handle 17, and the handle 19, which is farther from the blade 9, is hereinafter also referred to as a rear handle 19. Further, a direction that is orthogonal to a face of the blade 9 (or the extension direction of the axis A1) is defined as an up-down direction of the hedge trimmer 1A. In the up-down direction, the direction from the blade 9 toward the motor 2 is defined as an upward direction, and the opposite direction (the direction from the motor 2 toward the blade 9) is defined as a downward direction. A direction that is orthogonal to the front-rear direction and the up-down direction is defined as a left-right direction of the hedge trimmer 1A.

The detailed structure of the hedge trimmer 1A is now described.

First, the body housing 11 and elements disposed within the body housing 11 are described.

As shown in FIG. 2, the body housing 11 is a hollow body. The body housing 11 houses the motor 2, the speed reducer 4 and the motion converting mechanism 7. The motor 2 is disposed within a motor housing 20. The speed reducer 4 is disposed within a gear housing 40.

The motion converting mechanism 7 is disposed within a crank housing 70. The motor housing 20, the gear housing 40 and the crank housing 70 are fixed to each other with screws to form a single (integral) unit. The motor housing 20, the gear housing 40 and the crank housing 70 are supported within the body housing 11 to be substantially immovable relative to the body housing 11.

The motor 2 is a brushless direct current (DC) motor. The motor 2 includes a stator 21, a rotor 22 and a motor shaft 23. The stator 21 is fixedly supported within the motor housing 20. The motor shaft 23 is fixed to the rotor 22 and rotates integrally with the rotor 22 around the axis A1 extending in the up-down direction. The motor shaft 23 is rotatably supported at upper and lower end portions by bearings 201, 202. The bearings 201, 202 are supported by the motor housing 20. In this embodiment, the motor shaft 23 is formed by multiple components connected to each other. However, the motor shaft 23 may be a single member.

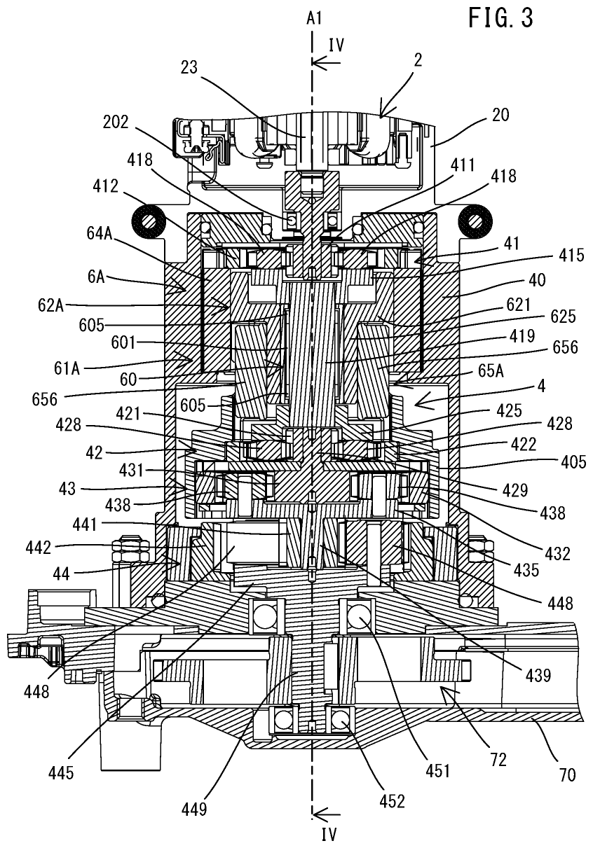

The speed reducer 4 is disposed coaxially with the motor 2 under the motor 2. The speed reducer 4 is operably coupled to the motor shaft 23 of the motor 2 and to the motion converting mechanism 7. The speed reducer 4 is configured to reduce the rotating speed and increase torque inputted from the motor shaft 23, and transmit or output them to the motion converting mechanism 7. As shown in FIG. 3, the speed reducer 4 is a multi-stage planetary speed reducer. Specifically, the speed reducer 4 includes four stages (sets) of planetary gear mechanisms housed in the gear housing 40. The four stages (sets) of planetary gear mechanisms are hereinafter respectively referred to as a first planetary gear mechanism 41, a second planetary gear mechanism 42, a third planetary gear mechanism 43 and a fourth planetary gear mechanism 44 in the order from the first stage (an input side or an upper side of the speed reducer 4, an upstream side in a torque transmission path).

A lower end portion of the motor shaft 23 protrudes into the gear housing 40. An input shaft of the speed reducer 4 is the motor shaft 23. A final output shaft of the speed reducer 4 is a shaft 449 that is integrally formed with a fourth carrier 445 of the fourth planetary gear mechanism 44. The shaft 449 is supported rotatably around the axis A1 by two bearings 451, 452 that are supported by the crank housing 70. A lower end portion of the shaft 449 is within the crank housing 70. The speed reducer 4 will be described in detail below.

As shown in FIG. 2, the motion converting mechanism 7 is disposed within the crank housing 70 below the speed reducer 4. The motion converting mechanism 7 is configured to convert rotation of the final output shaft (the shaft 449) of the speed reducer 4 into linear motion and to linearly reciprocate the blades 9. The motion converting mechanism 7 may have any known configuration. In this embodiment, the motion converting mechanism 7 is structured as a so-called crank mechanism, which includes a cam plate 72 and two connecting rods 731, 732.

The cam plate 72 is a disc-like member that is fixed around the shaft 449 of the fourth carrier 445. The cam plate 72 is configured to rotate integrally with the fourth carrier 445 around the axis A1. Cylindrical eccentric parts 721, 722 protrude upward and downward from upper and lower surfaces of the cam plate 72, respectively. Centers of the eccentric parts 721, 722 are offset from the axis A1 by the same distance and are opposite to each other across the axis A1. Rear end portions of the connecting rods 731, 732 are operably coupled to the eccentric parts 721, 722, respectively. Front end portions of the connecting rods 731, 732 are operably coupled to the two blades 9, respectively.

As shown in FIGS. 1 and 2, the two blades 9 are supported by a blade guide 97. The two blades 9 overlap each other in the up-down direction and extend in the front-rear direction. The blade guide 97 is fixed to a front end portion of the crank housing 70 and linearly extends forward from the crank housing 70. The blade guide 97 supports the blades 9 so as to be linearly movable in the front-rear direction within a prescribed range. The blades 9 linearly reciprocate in the front-rear direction in opposite phases (i.e., with a phase difference of 180 degrees) while the cam plate 72 rotates. Each of the blades 9 has cutting teeth (cutting part) 90 formed along each of left and right edges. An object to be cut is caught between a cutting tooth 90 of the upper blade 9 and a cutting tooth 90 of the lower blade 9 and cut as the blades 9 move relative to each other in the front-rear direction.

Each cutting tooth 90 is wedge-shaped and has cutting edges on front and rear sides. Thus, the blades 9 can cut the object irrespective of the direction of relative movement of the blades 9. Specifically, the blades 9 can cut the object both in a forward stroke, in which the upper blade 9 moves forward relative to the lower blade 9, and in a backward (reverse, return) stroke, in which the upper blade 9 moves backward relative to the lower blade 9.

The motion converting mechanism 7 may be configured to reciprocate only one of the blades 9 relative to the other blade 9 that is fixed (stationary), instead of reciprocating both of the blades 9 relative to the body housing 11 in the front-rear direction.

The front handle 17 is now described.

As shown in FIG. 1, the front handle 17 is U-shaped. The front handle 17 is integrally formed with the body housing 11, and both ends of the front handle 17 are respectively connected to left and right front end portions of the body housing 11. A central portion of the front handle 17 protrudes above the body housing 11 and functions as a grip part 171 to be held by a user.

The rear handle 19 and elements disposed within the rear handle 19 are now described.

As shown in FIGS. 1 and 2, the rear handle 19 is a hollow body having a loop-like shape (D-shape) when viewed from the side. The rear handle 19 is connected to a rear end portion of the body housing 11. A portion of the rear handle 19 that extends rearward from an upper rear end portion of the body housing 11 functions as a grip part 191 to be held by the user. The switch lever 193 is on a lower portion of the grip part 191. A switch 195 is disposed within the rear handle 19. The switch 195 is normally kept OFF, and turned ON when the switch lever 193 is manually depressed. The switch 195 is electrically connected to a controller 81 via wires (not shown). When turned ON, the switch 195 outputs a signal indicating an amount of operation (depression) of the switch lever 193 to the controller 81.

The controller 81 is disposed within a lower front end portion of the rear handle 19. Although not shown in detail, the controller 81 includes a circuit board and a control circuit mounted on the circuit board. In this embodiment, the control circuit is configured as a microcomputer including a CPU, a ROM, a memory and a timer, and controls operation of the hedge trimmer 1A, including driving of the motor 2. More specifically, when the controller 81 recognizes a signal from the switch 195, the controller 81 drives the motor 2 at a speed that is set in accordance with the amount of operation of the switch lever 193 that is indicated by the signal.

A manipulation part 85 is provided on an upper surface of the rear handle 19. The manipulation part 85 is an input device that is configured to be externally manipulated by the user for inputting various instructions. The manipulation part 85 includes push-button switches and is electrically connected to the controller 81 via wires (not shown). In this embodiment, the manipulation part 85 includes a main power switch 851 and a reverse switch 855.

The main power switch 851 is a switch for inputting an instruction to turn ON a main power source. The main power switch 851 is configured to be switched ON and OFF in response to a long press of the main power switch 851 and output a specific signal to the controller 81 when switched. The controller 81(control circuit) accepts a signal from the switch 195 as effective one only while the main power switch 851 is ON. Specifically, the controller 81 does not drive the motor 2 even if the switch 195 is turned ON while the main power switch 851 is OFF.

The reverse switch 855 is a switch for inputting an instruction to reverse the rotating direction of the motor 2 and thus the moving directions of the blades 9. The reverse switch 855 is configured to output a specific signal to the controller 81 when pressed. In this embodiment, the rotating direction of the motor 2 (specifically, the rotor 22 and the motor shaft 23) can be switched between a first direction and a second direction that is opposite to the first direction. The controller 81 (control circuit) sets the rotating direction of the motor 2 to the first direction when the main power switch 851 is turned ON. Thereafter, when recognizing a signal from the reverse switch 855, the controller 81 changes the rotating direction of the motor 2 to the second direction. The controller 81 thereafter switches the rotating direction of the motor 2 between the first direction and the second direction every time the controller 81 recognizes a signal from the reverse switch 855 while the main power switch 851 is ON.

Further, a display part 87 for displaying various information is disposed on the upper surface of the rear handle 19, adjacent to the manipulation part 85. Although not shown in detail, in this embodiment, the display part 87 is configured to display the ON/OFF state of the main power switch 851 and the rotating direction (i.e., an action mode) of the motor 2. The display part 87 indicates these information, for example, by lighting a lamp, flashing of the lamp, and/or change of the color of the light.

A battery mounting part 197 is provided in a lower end portion of the rear handle 19. A battery 198 is removably mounted to the battery mounting part 197. The battery 198 is a rechargeable power source for supplying power to various parts of the hedge trimmer 1A and the motor 2, and may also be referred to as a battery pack. The structures of the battery mounting part 197 and the battery 198 are well known and not therefore described here.

The speed reducer 4 is now described in detail.

As shown in FIGS. 3 to 5, in the speed reducer 4, the first planetary gear mechanism 41 in the first stage (on the input side) includes a first sun gear 411, a first internal gear (also referred to as a ring gear) 412, a first carrier 415 and a plurality of first planetary gears 418. In the first planetary gear mechanism 41, the first internal gear 412 serves as a fixed (stationary) element (is held stationary), the first sun gear 411 serves as an input element, and the first carrier 415 serves as an output element. The first internal gear 412 is always fixed (held stationary, immovable), so that the first planetary gear mechanism 41 always functions as a speed-reducing mechanism.

The first internal gear 412 is supported within the gear housing 40 such that the first internal gear 412 is substantially non-rotatable around the axis A1 relative to the gear housing 40. The first sun gear 411 is fixed to a lower end portion of the motor shaft 23 (i.e., the input shaft of the speed reducer 4). The first planetary gears 418 are supported by the first carrier 415 and mesh with the first sun gear 411 and the first internal gear 412. A shaft 419 is fixed to the first carrier 415 and extends downward along the axis A1.

The second planetary gear mechanism 42 in the second stage is disposed under the first planetary gear mechanism 41. The second planetary gear mechanism 42 includes a second sun gear 421, a second internal gear (also referred to as a ring gear) 422, a second carrier 425 and a plurality of second planetary gears 428. In the second planetary gear mechanism 42, the second internal gear 422 serves as a fixed (stationary) element, the second carrier 425 serves as an input element, and the second sun gear 421 serves as an output element. It is noted, however, the second internal gear 422 is selectively placed in a fixed (stationary) state (a locked state, a non-rotatable state) or in a rotatable state, depending on the rotating direction of the motor 2, so that the second planetary gear mechanism 42 selectively functions as a speed-increasing mechanism.

The second internal gear 422 is disposed within a sleeve 405. The sleeve 405 is a stepped hollow cylindrical member. The sleeve 405 is disposed within the gear housing 40 such that the sleeve 405 is spaced apart from the gear housing 40. The sleeve 405 is selectively rotatable around the axis A1 relative to the gear housing 40. The second internal gear 422 is configured to rotate integrally with the sleeve 405. Whether or not the second internal gear 422 is rotatable depends on the rotating direction of the motor 2, and switched by a speed-reducing-ratio change mechanism 6A, as will be described in detail below.

The second carrier 425 is fixed to a lower end portion of the shaft 419 extending from the carrier 415. Thus, the shaft 419 functions as an output shaft of the first planetary gear mechanism 41 and an input shaft of the second planetary gear mechanism 42. The second planetary gears 428 are supported by the second carrier 425 and mesh with the second internal gear 422 and the second sun gear 421. The second sun gear 421 is fixed around a shaft 429 extending downward along the axis A1.

The third planetary gear mechanism 43 in the third stage is disposed under the second planetary gear mechanism 42. The third planetary gear mechanism 43 includes a third sun gear 431, a third internal gear (also referred to as a ring gear) 432, a third carrier 435 and a plurality of third planetary gears 438. In the third planetary gear mechanism 43, the third internal gear 432 serves as a fixed (stationary) element, the third sun gear 431 serves as an input element, and the third carrier 435 serves as an output element. Like the second planetary gear mechanism 42, the third internal gear 432 is selectively placed in a fixed (stationary) state (a locked state, a non-rotatable state) or to a rotatable state, depending on the rotating direction of the motor 2, so that the third planetary gear mechanism 43 selectively functions as a speed-reducing mechanism.

The third internal gear 432 is disposed under the second internal gear 422 within the sleeve 405. Like the second internal gear 422, the third internal gear 432 is configured to rotate integrally with the sleeve 405. Thus, whether or not the third internal gear 432 is rotatable also depends on the rotating direction of the motor 2, and switched by the speed-reducing-ratio change mechanism 6A, as will be described below.

The third sun gear 431 is fixed to a lower end portion of the shaft 429. Thus, the second sun gear 421 and the third sun gear 431 are fixed to the same common shaft 429 and form a single member. This configuration facilitates assembling of the speed reducer 4. The shaft 429 functions as an output shaft of the second planetary gear mechanism 42 and an input shaft of the third planetary gear mechanism 43. The third planetary gears 438 are supported by the third carrier 435 and mesh with the third sun gear 431 and the third internal gear 432. The third carrier 435 has a shaft 439 extending downward along the axis A1.

The fourth planetary gear mechanism 44 in the fourth stage is disposed under the third planetary gear mechanism 43. The fourth planetary gear mechanism 44 includes a fourth sun gear 441, a fourth internal gear (also referred to as a ring gear) 442, a fourth carrier 445 and a plurality of fourth planetary gears 448. In the fourth planetary gear mechanism 44, the fourth internal gear 442 serves as a fixed (stationary) element, the fourth sun gear 441 serves as an input element, and the fourth carrier 445 serves as an output element. The fourth internal gear 442 is always fixed (held stationary, immovable), so that the fourth planetary gear mechanism 44 always functions as a speed-reducing mechanism.

The fourth internal gear 442 is supported within the gear housing 40 such that the fourth internal gear 442 is substantially non-rotatable around the axis A1 relative to the gear housing 40. The fourth sun gear 441 is fixed to a lower end portion of the shaft 439 extending from the third carrier 435. Thus, the shaft 439 functions as an output shaft of the third planetary gear mechanism 43 and an input shaft of the fourth planetary gear mechanism 44. The fourth planetary gears 448 are supported by the fourth carrier 445 and mesh with the fourth sun gear 441 and the fourth internal gear 442. The fourth carrier 445 has the shaft 449 extending downward along the axis A1. As described above, the shaft 449 functions as the final output shaft of the speed reducer 4.

The speed-reducing-ratio change mechanism 6A is now described. The speed-reducing-ratio change mechanism 6A is configured to selectively lock or rotate the second internal gear 422 and the third internal gear 432 of the speed reducer 4 relative to the gear housing 40, depending on the rotating direction of the motor 2. When the states of the second internal gear 422 and the third internal gear 432 are changed, the number of effective stages of the speed reducer 4 (the number of the planetary gear mechanisms that function effectively) and thus the speed reducing ratio of the speed reducer 4 are changed.

As shown in FIGS. 3 to 5, the speed-reducing-ratio change mechanism 6A includes a one-way clutch 60 and a lock mechanism 61A.

The one-way clutch 60 is configured to transmit rotation only in one direction and idle in the opposite direction. A general-purpose one-way clutch is employed as the one-way clutch 60 of this embodiment. The one-way clutch 60 is of a type having bearings 605 (radial bearings) on opposite sides of clutch members 601 (e.g., rollers or sprags) in an axial direction of the one-way clutch 60. Thus, the one-way clutch 60 is a single component (unit) in which the bearings 605 are incorporated (integrated).

The one-way clutch 60 is disposed in a torque transmission path in the speed reducer 4. More specifically, the one-way clutch 60 is fitted around the shaft 419 that is integrated with the first carrier 415. When the shaft 419 rotates in the first direction, the one-way clutch 60 idles relative to the shaft 419. In other words, the one-way clutch 60 does not transmit rotation. On the other hand, when the shaft 419 rotates in the second direction, which is opposite to the first direction, the one-way clutch 60 rotates integrally with the shaft 419. In other words, the one-way clutch 60 is locked to the shaft 419 and rotates integrally with the shaft 419, and thus transmits rotation.

The lock mechanism 61A is configured to switch the states of the second internal gear 422 and the third internal gear 432, depending on whether or not the one-way clutch 60 transmits rotation. The lock mechanism 61A includes a retainer 62A, two rollers 63, a lock sleeve 64A and a lock cam 65A.

The retainer 62A is a tubular member, which has a through hole through which the shaft 419 is inserted. The retainer 62A is configured to retain the rollers 63 such that the rollers 63 are movable relative to the retainer 62A in a circumferential direction around the axis A1. The retainer 62A is further configured to be selectively engaged with the lock cam 65A and rotated integrally with the lock cam 65A.

The retainer 62A includes a base part 621, four projections 623 and a hollow cylindrical part 625. The base part 621 is an annular portion. The projections 623 are circular arc walls arranged substantially at equal intervals along an outer edge portion of the base part 621. The projections 623 extends downward from the outer edge portion of the base part 621. Thus, four spaces are defined between the projections 623 in the circumferential direction. The cylindrical part 625 has a smaller outer diameter than that of the base part 621 and extends downward from a central portion of the base part 621 along the axis A1.

The one-way clutch 60 is fixed on an inner surface of the cylindrical part 625 of the retainer 62A. Thus, the retainer 62A rotates integrally with the one-way clutch 60. Therefore, the retainer 62A selectively rotates relative to the shaft 419. Specifically, when the shaft 419 rotates in the first direction, the retainer 62A idles integrally with the one-way clutch 60 relative to the shaft 419. In other words, the retainer 62A does not rotate together with the shaft 419. At this time, the bearings 605 of the one-way clutch 60 secure smooth rotation of the shaft 419 relative to the retainer 62A. On the other hand, when the shaft 419 rotates in the second direction, the retainer 62A rotates integrally with the shaft 419 together with the one-way clutch 60.

Each of the rollers 63 is a solid cylindrical member (pin). The roller 63 has a substantially uniform diameter that is smaller than the distance between the adjacent projections 623 of the retainer 62A and that is larger than the thickness of the projections 623 in a radial direction of the retainer 62A. The two rollers 63 are disposed in two diametrically opposed ones of the four spaces defined between the projections 623 of the retainer 62A such that axes of the rollers 63 extend substantially in the up-down direction.

The lock sleeve 64A is a hollow, generally cylindrical member. The lock sleeve 64A is disposed around (radially outside of) the retainer 62A under the first internal gear 412 so as to be coaxial with the retainer 62A. The lock sleeve 64A is supported within the gear housing 40 such that the lock sleeve 64A is substantially non-rotatable around the axis A1 relative to the gear housing 40. The projections 623 of the retainer 62A and rollers 63 are arranged inside (radially inward of) the lock sleeve 64A.

The lock cam 65A is operably coupled to the retainer 62A and selectively rotated by the retainer 62A. The lock cam 65A is basically a tubular member, and is arranged coaxially with the retainer 62A.

More specifically, the lock cam 65A includes a tubular part 651, and two projections 656 protruding radially outward from the tubular part 651. The tubular part 651 has a through hole having a circular section and extending along the axis A1. An outer peripheral surface of the tubular part 651 includes two flat surface parts 652. The flat surface parts 652 are diametrically opposed to each other across the axis A1 and extend in parallel to each other and in parallel to the axis A1. The projections 656 are diametrically opposed to each other across the axis A1 and protrude radially outward from the outer peripheral surface of the tubular part 651. The two projections 656 are respectively arranged between the two flat surface parts 652 in a circumferential direction of the tubular part 651. A portion of the outer peripheral surface of the tubular part 651 between the flat surface part 652 and the projection 656 is a curved surface corresponding to an outer peripheral surface of a cylinder.

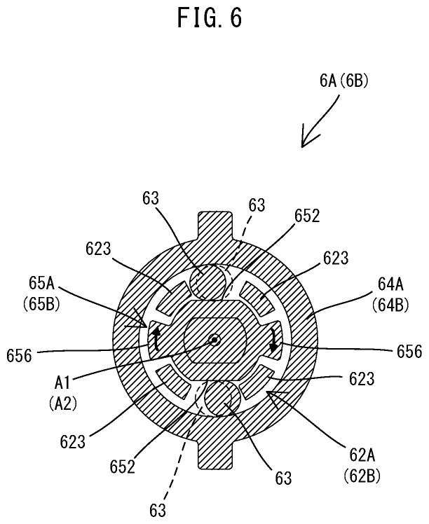

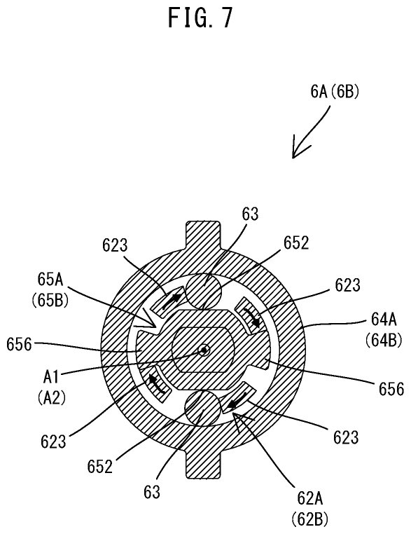

As shown in FIG. 6, the distance between the flat surface part 652 and an inner peripheral surface of the lock sleeve 64A in the radial direction is maximum at the center of the flat surface part 652, and this distance is set to be slightly larger than the diameter of the roller 63. The radial distance between the flat surface part 652 and the inner peripheral surface of the lock sleeve 64A gradually decreases from the center to both ends of the flat surface part 652 in the circumferential direction. The radial distance between each of the ends of the flat surface part 652 and the inner peripheral surface of the lock sleeve 64A is set to be smaller than the diameter of the roller 63. It is noted that FIG. 6 merely schematically shows a section of the lock mechanism 61A, for illustrating the operation principle of the lock mechanism 61A. As such, FIG. 6 does not accurately correspond to the actual shape (dimensions) of the lock mechanism 61A. This is also true for FIG. 7, which will be referred to below.

The lock cam 65A having the above-described structure is fitted around the cylindrical part 625 of the retainer 62A from below. The two projections 656 of the lock cam 65A are arranged in two of the four spaces defined between the projections 623 of the retainer 62A in the circumferential direction (specifically, in two spaces in which the rollers 63 are not disposed). Portions of the tubular part 651 other than portions having the projections 656 are disposed in a space defined between the cylindrical part 625 and the projections 623 of the retainer 62A in the radial direction. The rollers 63 are each disposed between the flat surface part 652 of the lock cam 65A and the inner peripheral surface of the lock sleeve 64A in the radial direction.

The lock cam 65A is connected to the sleeve 405 via the projections 656. Thus, the lock cam 65A can selectively rotate integrally with the sleeve 405 around the axis A1 relative to the gear housing 40. As described above, the second internal gear 422 and the third internal gear 432 rotate integrally with the sleeve 405. Thus, the lock cam 65A can selectively rotate integrally with the second internal gear 422 and the third internal gear 432.

Operation of the speed-reducing-ratio change mechanism 6A (the one-way clutch 60 and the lock mechanism 61A) is now described.

First, the operation of the speed-reducing-ratio change mechanism 6A when the motor 2 rotates in the first direction is described.

When the motor shaft 23 starts to rotate in the first direction, the first carrier 415 and the shaft 419 also rotate in the first direction around the axis A1. At this time, as described above, the one-way clutch 60 idles relative to the shaft 419 and does not transmit rotation to the retainer 62A. Therefore, the retainer 62A does not rotate actively.

The second carrier 425 fixed to the shaft 419 also rotates in the first direction around the axis A1. The second planetary gears 428 supported by the second carrier 425 cause the second internal gear 422 and the sleeve 405 to rotate in the second direction relative to the gear housing 40. At this time, the lock cam 65A connected to the sleeve 405 also rotates in the second direction (in the direction of arrows in FIG. 6). Accordingly, each of the rollers 63 relatively moves from a position shown by a dotted line in FIG. 6 toward the end of the flat surface part 652 in the circumferential direction.

As shown by a solid line in FIG. 6, each of the rollers 63 is held like a wedge between the flat surface part 652 and the inner peripheral surface of the lock sleeve 64A at a position closer to the end of the flat surface part 652 than to the center before the projections 656 of the lock cam 65A abut on the projections 623 of the retainer 62A. This position of the roller 63 relative to the lock sleeve 64A and the lock cam 65A is hereinafter also referred to as a lock position, and this state of the lock mechanism 61A is hereinafter also referred to as a locked state. In this manner, the lock cam 65A is locked to the lock sleeve 64A and thus to the gear housing 40 via the rollers 63 and prevented from rotating relative to the gear housing 40.

When the lock cam 65A is locked, the sleeve 405 and thus the second and third internal gears 422, 432 are also locked such that the second and third internal gears 422, 432 are non-rotatable relative to the gear housing 40. Accordingly, from then on, the second and third internal gears 422, 432 each function as a fixed (stationary) element. The second planetary gears 428 revolve around the second sun gear 421 while rotating, and cause the second sun gear 421 and the shaft 429 to rotate in the first direction. The third sun gear 431 fixed around the shaft 429 also rotates in the first direction, and causes the third carrier 435 to rotate in the first direction via the third planetary gears 438.

As described above, when the motor shaft 23 rotates in the first direction and the one-way clutch 60 does not transmit rotation to the retainer 62A, the lock mechanism 61A non-rotatably locks the second and third internal gears 422, 432. As a result, the lock mechanism 61A causes the second and third planetary gear mechanisms 42, 43 to function effectively. Thus, the number of effective stages in the speed reducer 4 is four (4) when the motor shaft 23 rotates in the first direction.

Next, the operation of the speed-reducing-ratio change mechanism 6A when the motor 2 rotates in the second direction is described.

When the motor shaft 23 starts to rotate in the second direction, the first carrier 415 and the shaft 419 also rotate in the second direction. At this time, as described above, the one-way clutch 60 is locked to the shaft 419 and transmits rotation of the shaft 419 to the retainer 62A. Therefore, the retainer 62A also rotates in the second direction (in the direction of arrows shown in FIG. 7).

As shown in FIG. 7, two of the four projections 623 of the retainer 62A respectively abut (contact) and push the projections 656 of the lock cam 65A in the second direction. At the same time, the other two projections 623 respectively abut (contact) and push the rollers 63 in the second direction up to a position where each roller 63 is disengaged from between the flat surface part 652 and the inner peripheral surface of the lock sleeve 64A (a position substantially corresponding to the center of the flat surface part 652, in this embodiment). This position of the roller 63 relative to the lock sleeve 64A and the lock cam 65A is hereinafter also referred to as an unlock position, and this state of the lock mechanism 61A is hereinafter also referred to as an unlocked state.

When the rollers 63 are moved to their respective unlock positions, the lock cam 65A can rotate relative to the lock sleeve 64A and thus to the gear housing 40. Therefore, rotation of the retainer 62A is transmitted to the lock cam 65A, and the lock cam 65A rotates integrally with the shaft 419 and the retainer 62A in the second direction. As a result, the second and third internal gears 422, 432 rotate integrally with the shaft 419 and the second carrier 425 in the second direction.

The second planetary gears 428 supported by the second carrier 425 cannot rotate (on their respective axes) since the second carrier 425 rotates integrally with the second internal gear 422. As a result, the second sun gear 421 rotates integrally with the second carrier 425 and the second internal gear 422 in the second direction. The shaft 429 (the output shaft of the second planetary gear mechanism 42) rotates at the same speed as the shaft 419 (the input shaft of the second planetary gear mechanism 42), so that the second planetary gear mechanism 42 does not function as a speed-increasing mechanism.

The third planetary gears 438 supported by the third carrier 435 cannot rotate (on their respective axes) since the third sun gear 431 fixed around the shaft 429 rotates integrally with the third internal gear 432. As a result, the third carrier 435 rotates integrally with the third sun gear 431 and the third internal gear 432 in the second direction. The shaft 439 (the output shaft of the third planetary gear mechanism 43) rotates at the same speed as the shaft 429 (the input shaft of the third planetary gear mechanism 43), so that the third planetary gear mechanism 43 does not function as a speed-reducing mechanism.

As described above, when the motor shaft 23 rotates in the second direction and the one-way clutch 60 transmits rotation to the retainer 62A, the lock mechanism 61A rotates the second and third internal gears 422, 432 integrally with the shaft 419 in the same direction. Thus, the lock mechanism 61A disables the functions of the second and third planetary gear mechanisms 42, 43, so that the number of effective stages in the speed reducer 4 becomes two (2) when the motor shaft 23 rotates in the second direction.

As described above, the number of effective stages of the speed reducer 4 is switched between four and two, depending on the rotating direction of the motor 2. In this embodiment, an entirety of the second and third planetary gear mechanisms 42, 43 is configured to function as a speed-increasing mechanism. In other words, the second and third planetary gear mechanisms 42, 43 are configured such that an output speed of the third planetary gear mechanism 43 is higher than an input speed of the second planetary gear mechanism 42. Specifically, the reciprocal of the speed increasing ratio (transmission ratio of less than 1) of the effectively functioning second planetary gear mechanism 42 is larger than the speed reducing ratio (transmission ratio of 1 or more) of the effectively functioning third planetary gear mechanism 43. Thus, the relation of N2/N1>N2/N3 is satisfied, where N1, N2, N3 are the rotating speeds of the shafts 419, 429, 439, respectively. Further, although not described in detail, the speed reducing ratios of the first and fourth planetary gear mechanisms 41, 44 are each set such that an entirety of the speed reducer 4 functions as a speed-reducing mechanism.

Therefore, the shaft 449 rotates at lower speed and outputs higher torque when only two stages of the speed reducer 4 are effective (when the motor 2 rotates in the second direction and the second and third internal gears 422, 432 rotate) than when all four stages of the speed reducer 4 are effective (when the motor 2 rotates in the first direction and the second and third internal gears 422, 432 are locked). Accordingly, an action mode of the speed reducer 4 in which the two stages of the speed reducer 4 are effective is referred to as a low-speed and high-torque mode, and another action mode of the speed reducer 4 in which the four stages of the speed reducer 4 are effective is referred to as a high-speed and low-torque mode. Particularly, in this embodiment, in the low-speed and high-torque mode, torque can be effectively increased owing to rotation of the second and third internal gears 422, 432.

In this embodiment, the speed reducer 4 is configured such that the speed reducing ratio of the entirety of the speed reducer 4 in the low-speed and high-torque mode is less than 2.5 times that in the high-speed and low-torque mode. The speed reducing ratio (transmission ratio) of the speed reducer 4 is expressed as Ni/No, where Ni is an input rotating speed (an input speed, the rotating speed of the motor shaft 23) and No is an output rotating speed (an output speed, the rotating speed of the shaft 449). Therefore, if the input speed Ni of the speed reducer 4 is the same, the output speed Noh of the speed reducer 4 in the high-speed and low-torque mode is less than 2.5 times the output speed Nol of the speed reducer 4 in the low-speed and high-torque mode. Thus, the output speeds Nol and Noh satisfy the relation of Noh<Nol×2.5.

If a planetary gear mechanism is structured as a speed-reducing mechanism having a fixed (stational) internal gear, an input sun gear and an output carrier, the speed reducing ratio (transmission ratio) depends on the numbers of teeth of the sun gear and the internal gear. Specifically, the speed reducing ratio (transmission ratio) is expressed as 1+(Zi/Zs), where Zs is the number of teeth of the sun gear and Zi is the number of teeth of the internal gear. Reduction of Zi/Zs and thus reduction of the speed reducing ratio of each of the planetary gear mechanisms are limited since the planetary gears are disposed between the sun gear and the internal gear. Accordingly, in a multi-stage planetary speed reducer, if the speed reducing ratio is changed by enabling or disabling the function of at least one speed-reducing planetary gear mechanism having a fixed internal gear, the speed reducing ratio and thus the output speed tend to be relatively greatly changed.

Generally, the speed reducing ratio of an individual planetary gear mechanism becomes about 3 or more. Thus, when the function of one speed-reducing planetary gear mechanism included in the multi-stage planetary speed reducer is enabled or disabled, the speed reducing ratio (or the output speed) of an entirety of the speed reducer in the low-speed and high-torque mode tend to become about 3 times or more that in the high-speed and low-torque mode.

In the speed reducer 4 of this embodiment, however, among the four planetary gear mechanisms, the second planetary gear mechanism 42 is structured as a speed-increasing mechanism, and the other three planetary gear mechanisms are structured as speed-reducing mechanisms. The speed reducing ratio is changed by enabling or disabling the functions of two planetary gear mechanisms (the second and third planetary gear mechanisms 42, 43) including a speed-increasing mechanism and a speed-reducing mechanism.

In this case, the speed increasing ratio (transmission ratio) of the entirety of the two planetary gear mechanisms 42, 43 can be flexibly set by properly combining the speed increasing ratio of the second planetary gear mechanism 42 and the speed reducing ratio of the third planetary gear mechanism 43. Specifically, the reciprocal of the speed increasing ratio (<1) of the entirety of the two stages of planetary gear mechanisms can be made smaller than the speed reducing ratio (>1) of one planetary gear mechanism having a fixed internal gear. In this manner, as compared with a known multi-stage planetary speed reducer in which internal gears serve as fixed elements in all of the planetary gear mechanisms that function as speed reducing mechanisms and the function of at least one of the planetary gear mechanisms is enabled or disabled, the change of the speed reducing ratio and thus the change of the output speed of the entirety of the speed reducer 4 can be made smaller.

Further, in this embodiment, the second planetary gear mechanism 42, which is a speed-increasing mechanism, is in the former (previous) stage (on the input side) of the third planetary gear mechanism 43, which is a speed-reducing mechanism. Owing to this configuration, torque that is transmitted from the second planetary gear mechanism 42 to the third planetary gear mechanism 43 can be made smaller than torque that is transmitted from a speed-reducing mechanism to a speed-increasing mechanism in a structure in which the speed-reducing mechanism is in the former stage (on the input side) of the speed-increasing mechanism. Therefore, the configuration of this embodiment is preferable in that the strength required for the gears can be made smaller, and thus the gears can be made compact. In contrast to this embodiment, however, the speed-reducing mechanism may be in the former stage (on the input side) of the speed-increasing mechanism. In such a modification, like in this embodiment, the speed increasing ratio or speed reducing ratio (transmission ratio) of the entirety of the two stages of planetary gear mechanisms may be properly set.

Operation of the hedge trimmer 1A in performing a cutting operation (pruning operation, trimming operation) is now described.

A user first long-press the main power switch 851 to turn it ON. The user then presses the reverse switch 855, if necessary, according to an object to be cut. Specifically, when cutting relatively thin branches and leaves, only a relatively small cutting force is required, so that the high-speed and low-torque mode is preferred from the viewpoint of cutting efficiency. Therefore, the user maintains the rotating direction of the motor 2 to the first direction without pressing the reverse switch 855. On the other hand, when cutting relatively thick branches, a relatively large cutting force is required, so that the low-speed and high-torque mode is preferred. Therefore, the user presses the reverse switch 855 to change the rotating direction of the motor 2 from the first direction to the second direction.

Thereafter, when the user depresses the switch lever 193, the controller 81 (control circuit) drives the motor 2 at a speed that corresponds to the amount of operation (depression) of the switch lever 193. The speed reducer 4 operates with an appropriate number of effective stages, according to the rotating direction (action mode) of the motor 2 as described above. The shaft 449 causes the two blades 9 to reciprocate in opposite directions in the front-rear direction via the motion converting mechanism 7. Then, the object is cut by the reciprocating blades 9.

During the cutting operation, scraps of branches and leaves may get entangled between the cutting teeth 90 of the upper blade 9 and the cutting teeth 90 of the lower blade 9. In such a case, the user can change the rotating direction of the motor 2 by pressing the reverse switch 855. Thereafter, when the switch lever 193 is pressed, the moving directions of the blades 9 are reversed, so that the entangled blanches and leaves can be easily removed. Particularly, in a case where the rotating direction of the motor 2 is changed from the first direction to the second direction (from the high-speed and low-torque mode to the low-speed and high-torque mode), the cutting teeth 90 biting the branches can be easily removed from the branches.

As described above, the speed reducer 4 of this embodiment is a multi-stage planetary speed reducer, and the number of effective stages of the speed reducer 4 is changed according to the rotating direction of the motor 2 (the motor shaft 23), and accordingly, the speed reducing ratio of the speed reducer 4 and thus the output speed and output torque of the speed reducer 4 are changed. Therefore, the hedge trimmer 1A can selectively perform either one of the two actions that are different in the required output speed and output torque, simply in response to the change of the rotating direction of the motor 2 without need for controlling the rotating speed of the motor 2.

In the hedge trimmer 1A, a significant increase of the output torque is not usually required. On the other hand, a significant decrease of the output speed is undesirable since it leads to significant reduction of the working efficiency. As described above, in the speed reducer 4 of this embodiment, the change of the speed reducing ratio and thus the change of the output speed of the entirety of the speed reducer 4 are relatively small. Thus, the speed reducer 4 has preferable characteristics for the hedge trimmer 1A.

Correspondences between the features of the first embodiment and the features of the present disclosure are as follows. However, the features of the first embodiment are merely exemplary and do not limit the features of the present disclosure.

The hedge trimmer 1A is an example of a “power tool” and a “cutting tool”. The motor 2 and the motor shaft 23 are examples of a “motor” and a “motor shaft”, respectively. The speed reducer 4 is an example of a “speed reducer”. The speed-reducing-ratio change mechanism 6A is an example of a “speed-reducing-ratio change mechanism”. The first planetary gear mechanism 41, the second planetary gear mechanism 42, the third planetary gear mechanism 43 and the fourth planetary gear mechanism 44 are examples of “planetary gear mechanisms arranged in multiple stages”. The one-way clutch 60 is an example of a “one-way clutch”. The second direction of the two opposite rotating directions of the motor shaft 23 is an example of “specific one of the two directions”. The lock mechanism 61A is an example of a “lock mechanism”. The second planetary gear mechanism 42 and the third planetary gear mechanism 43 are an example of “at least two stages of the planetary gear mechanisms”. The second internal gear 422 and the third internal gear 432 are an example of “internal gears of the at least two stages of the planetary gear mechanisms”. The second planetary gear mechanism 42 is an example of a “speed-increasing planetary gear mechanism”. The third planetary gear mechanism 43 is an example of a “speed-reducing planetary gear mechanism”. The clutch member 61 is an example of a “clutch member”. The bearing 605 is an example of a “second bearing”. The upper blade 9 is an example of a “first blade”. The lower blade 9 is an example of a “second blade”.

### Second Embodiment

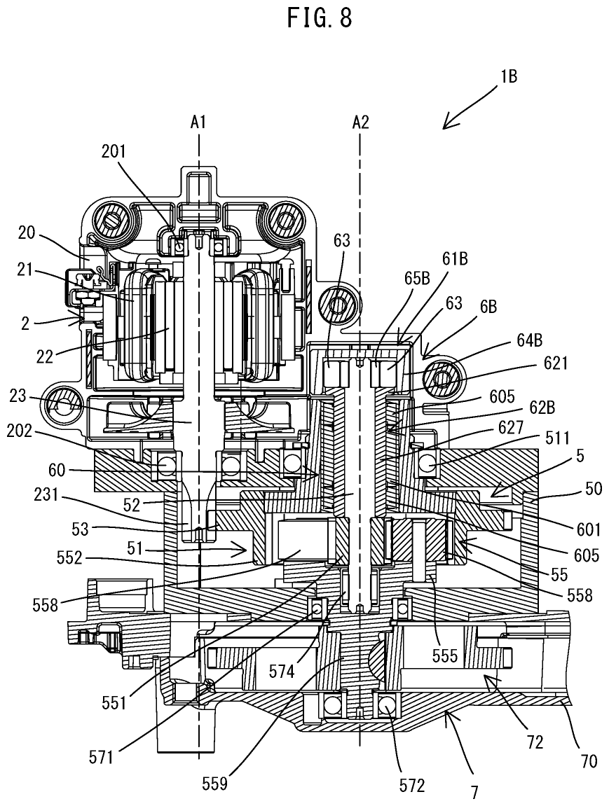

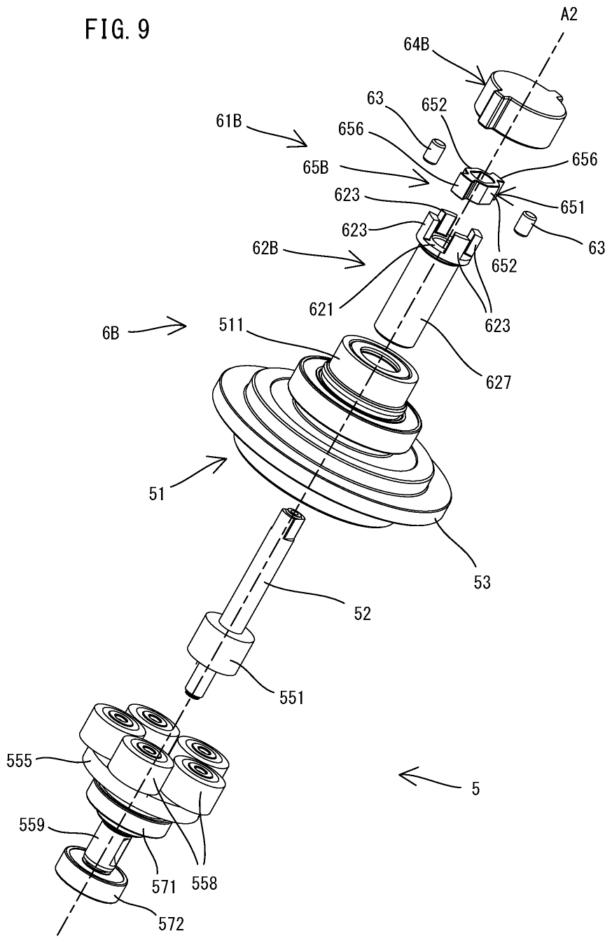

A hedge trimmer 1B according to a second embodiment of the present disclosure is now described with reference to FIGS. 8 and 9. The hedge trimmer 1B of this embodiment has substantially the same structure in part as the hedge trimmer 1A of the first embodiment. Therefore, in the following description, elements or components of the hedge trimmer 1B that are substantially identical to those of the hedge trimmer 1A (including those slightly different in shape) are given the same numerals and not described/shown or briefly described, and different points are mainly described.

Although not shown, like the hedge trimmer 1A of the first embodiment, the hedge trimmer 1B of the second embodiment has the body housing 11 and handles 17, 19 (see FIG. 2). As shown in FIG. 8, the motor 2, a speed reducer 5 and the motion converting mechanism 7 are disposed within the body housing 11 of the hedge trimmer 1B. It is noted that the connecting rods 731, 732 of the motion converting mechanism 7 are not shown in FIG. 8. The motor 2 is housed in the motor housing 20. The speed reducer 5 is housed in a gear housing 50. The motion converting mechanism 7 is housed in the crank housing 70. The motor housing 20, the gear housing 50 and the crank housing 70 are fixed to each other with screws to form a single (integral) unit, and supported within the body housing 11 to be substantially immovable relative to the body housing 11.

Like in the first embodiment, the motor 2 is a brushless DC motor. The motor shaft 23 is supported rotatably around the axis A1, which extends in the up-down direction. A lower end portion of the motor shaft 23 protrudes into the gear housing 50. The lower end portion of the motor shaft 23 has a driving gear (pinion) 231. The rotating direction of the motor 2 (specifically, the rotor 22 and the motor shaft 23) can be switched between a first direction and a second direction, which is opposite to the first direction.

The speed reducer 5 is disposed in front of the motor 2 in the front-rear direction. The speed reducer 5 is operably coupled to the motor shaft 23 of the motor 2 and to the motion converting mechanism 7. The speed reducer 5 is configured to reduce the rotating speed and increase torque inputted from the motor shaft 23 and transmit or output them to the motion converting mechanism 7. In this embodiment, the speed reducer 5 includes a reduction gear 53 and a single stage (set) of a planetary gear mechanism 55.

The reduction gear 53 is a driven gear that has a large diameter and that meshes with the driving gear (pinion) 231 of the motor shaft 23. The reduction gear 53 is provided on a gear sleeve 51. More specifically, the gear sleeve 51 is basically a stepped hollow cylindrical member. The gear sleeve 51 includes a large-diameter part and a small-diameter part having a smaller inner diameter than that of the large-diameter part. A lower end portion of the gear sleeve 51 forms the large-diameter part and the remaining portion of the gear sleeve 51 forms the small-diameter part. The gear sleeve 51 (an internal gear 552) is supported by a bearing 511 that is supported by the gear housing 50 such that the gear sleeve 51 is rotatable around the axis A2 relative to the gear housing 50. The axis A2 extends in parallel to the axis A1 (i.e., in the up-down direction) in front of the axis A1. A flange part protrudes radially outward from an outer periphery of the large-diameter part of the gear sleeve 51. The reduction gear 53 is formed along an outer edge of the flange part and meshes with the driving gear 231. The gear sleeve 51 rotates at a speed that is lower than the motor shaft 23 in a direction opposite to the rotating direction of the motor shaft 23 when the motor shaft 23 rotates.

The planetary gear mechanism 55 includes a sun gear 551, an internal gear (also referred to as a ring gear) 552, a carrier 555 and a plurality of planetary gears 558. In the planetary gear mechanism 55, the sun gear 551 serves as a fixed (stationary) element, the internal gear 552 serves as an input element, and the carrier 555 serves as an output element. The sun gear 551 is selectively switched between a fixed state (a locked state, non-rotatable state) and a rotatable state, depending on the rotating direction of the motor 2, so that the planetary gear mechanism 55 selectively functions as a speed-reducing mechanism.

The internal gear 552 is formed within the large-diameter part of the gear sleeve 51. Thus, the internal gear 552 is supported by the bearing 511, so that the internal gear 552 can stably rotate relative to the gear housing 50. Further, a shaft 52 is inserted through the gear sleeve 51 and extends along the axis A2. The one-way clutch 60 and a retainer 62B of a speed-reducing-ratio change mechanism 6B are disposed between the gear sleeve 51 and the shaft 52, as will be described below in detail. Whether or not the shaft 52 and thus the sun gear 551 is rotatable depends on the rotating direction of the motor 2, and is switched by the speed-reducing-ratio change mechanism 6B. The sun gear 551 is fixed around a lower portion of the shaft 52 that is disposed inside (radially inward of) the internal gear 552.

The planetary gears 558 are supported by the carrier 555 and mesh with the sun gear 551 and the internal gear 552. The carrier 555 is arranged coaxially with the shaft 52 below the sun gear 551. The carrier 555 has a shaft 559 extending downward along the axis A2. The shaft 559 is supported rotatably around the axis A2 by two bearings 571, 572 that are supported by the crank housing 70. The shaft 559 functions as a final output shaft of the speed reducer 5. A recess is formed in an upper end portion of the carrier 555. A bearing 574 is fitted in the recess and rotatably supports a lower end portion of the shaft 52.

In this embodiment, the speed-reducing-ratio change mechanism 6B is configured to selectively lock or rotate the shaft 52 and thus the sun gear 551 relative to the gear housing 50, depending on the rotating direction of the motor 2. When the state of the sun gear 551 is changed, the number of effective stages of the speed reducer 5 and thus the speed reducing ratio of the speed reducer 5 are changed. The speed-reducing-ratio change mechanism 6B has the same basic structure as the speed-reducing-ratio change mechanism 6A (see FIG. 3) of the first embodiment. Specifically, the speed-reducing-ratio change mechanism 6B includes the one-way clutch 60 and a lock mechanism 61B. The lock mechanism 61B includes the retainer 62B, two rollers 63, a lock sleeve 64B and a lock cam 65B. Although different in shape and arrangement, these elements or components of the lock mechanism 61B have basically the same functions as those of the lock mechanism 61A of the first embodiment, respectively.

The retainer 62B includes the annular base part 621, the four projections 623 protruding from the base part 621, and a sleeve part 627. The sleeve part 627 has a hollow cylindrical shape having a smaller outer diameter than that of the base part 621. The sleeve part 627 protrudes coaxially with the base part 621 from a central portion of the base part 621 in a direction opposite to the direction in which the projections 623 protrude. The sleeve part 627 is inserted through the gear sleeve 51 along the axis A2. The base part 621 and the projections 623 are disposed above the gear sleeve 51. The two rollers 63 are disposed in two diametrically opposed ones of the four spaces defined between the projections 623 of the retainer 62B in the circumferential direction such that axes of the rollers 63 extend in the up-down direction.

The lock sleeve 64B is basically a bottomed hollow cylindrical member. The lock sleeve 64B is arranged coaxially with the retainer 62B around (radially outward of) the base part 621 and the projections 623. The lock sleeve 64B is supported within the gear housing 50 to be substantially non-rotatable around the axis A2 relative to the gear housing 50.

The lock cam 65B is operably engaged with the retainer 62B and selectively rotated by the retainer 62B. The lock cam 65B is basically a tubular member. The lock cam 65B is arranged coaxially with the retainer 62B. Like in the first embodiment, the lock cam 65B includes the tubular part 651, and the two projections 656 protruding radially outward from the tubular part 651. The tubular part 651 is disposed inside (radially inward of) the projections 623 of the retainer 62B, and the two projections 656 are disposed in two of the four spaces defined between the projections 623 in the circumferential direction (specifically, in two spaces in which the rollers 63 are not disposed).

Further, in this embodiment, the lock cam 65B is connected to the shaft 52 and selectively rotates integrally with the shaft 52 around the axis A2 relative to the gear housing 50. The sun gear 551 is fixed around the shaft 52 as described above, so that the lock cam 65B can be selectively rotated integrally with the sun gear 551.

The one-way clutch 60 is disposed between the small-diameter part of the gear sleeve 51 and the retainer 62B. The one-way clutch 60 is fixed within the small-diameter part of the gear sleeve 51 and thus rotates integrally with the gear sleeve 51. When the motor shaft 23 rotates in the first direction and the gear sleeve 51 rotates in the second direction, the one-way clutch 60 idles relative to the retainer 62B. Thus, the one-way clutch 60 does not transmit rotation from the gear sleeve 51 to the retainer 62B. At this time, the bearings 605 of the one-way clutch 60 secure smooth rotation of the gear sleeve 51 relative to the retainer 62B. On the other hand, when the motor shaft 23 rotates in the second direction and the gear sleeve 51 rotates in the first direction, the one-way clutch 60 rotates integrally with the retainer 62B and transmits rotation from the gear sleeve 51 to the retainer 62B.

Operation of the speed-reducing-ratio change mechanism 6B (the one-way clutch 60 and the lock mechanism 61B) is now described.

First, the operation of the speed-reducing-ratio change mechanism 6B when the motor 2 rotates in the first direction is described.

When the motor shaft 23 rotates in the first direction, the gear sleeve 51 and the internal gear 552 rotate in the second direction. As described above, the one-way clutch 60 does not transmit rotation to the retainer 62B at this time, so that the retainer 62B does not rotate actively. The internal gear 552 causes the sun gear 551 and the shaft 52 to rotate in the first direction via the planetary gears 558. At this time, the lock cam 65B connected to the shaft 52 also rotates in the first direction (in the direction of the arrows in FIG. 6), and accordingly, each of the rollers 63 relatively moves toward the end of the flat surface part 652 from a position shown by the dotted line in FIG. 6.

When the rollers 63 are each moved to the lock position as shown by the solid line in FIG. 6, the lock cam 65B is locked to be non-rotatable relative to the gear housing 50, and thus the sun gear 551 is also locked to be non-rotatable relative to the gear housing 50. Accordingly, from then on, the sun gear 551 functions as the fixed element. When the internal gear 552 rotates in the second direction, the planetary gears 558 revolve around the sun gear 551 while rotating, and cause the carrier 555 to rotate in the second direction.

As described above, when the motor shaft 23 rotates in the first direction, the lock mechanism 61B causes the planetary gear mechanism 55 to function effectively. Thus, the number of effective stage of the speed reducer 5 is one (1) when the motor shaft 23 rotates in the first direction. Therefore, in the speed reducer 5, speed reduction is performed by the driving gear 231 and the reduction gear 53, and subsequently further performed by the planetary gear mechanism 55.

Next, the operation of the speed-reducing-ratio change mechanism 6B when the motor 2 rotates in the second direction is described.

When the motor shaft 23 rotates in the second direction, the gear sleeve 51 and the internal gear 552 rotate in the first direction. As described above, the one-way clutch 60 transmits rotation of the gear sleeve 51 to the retainer 62B, so that the retainer 62B also rotates in the first direction (in the direction of the arrows shown in FIG. 7). As shown in FIG. 7, the two of the projections 623 of the retainer 62B respectively abut (contact) and push the projections 656 of the lock cam 65B in the first direction. At the same time, the other two projections 623 respectively abut (contact) and push the rollers 63 in the first direction to their respective unlock positions. Thus, from then on, the lock cam 65B and the sun gear 551 rotate integrally with the internal gear 552 and the retainer 62B in the first direction. As a result, the carrier 555 also rotates in the first direction at the same speed as the internal gear 552.

As described above, when the motor shaft 23 rotates in the second direction, the lock mechanism 61B disables the function of the planetary gear mechanism 55. Thus, the number of effective stages of the speed reducer 5 becomes zero (0) when the motor shaft 23 rotates in the second direction. In other words, in the speed reducer 5, speed reduction is performed only by the driving gear 231 and the reduction gear 53. Therefore, in this embodiment, the speed reducer 5 operates in the low-speed and high-torque mode when the number of effective stages is one (when the motor 2 rotates in the first direction and the sun gear 551 is locked), and operates in the high-speed and low-torque mode when the number of effective stages is zero (when the motor 2 rotates in the second direction and the sun gear 551 rotates).

The planetary gear mechanism 55 of this embodiment is structured as a speed-reducing mechanism that includes a fixed sun gear, an input internal gear and an output carrier, and its speed reducing ratio (transmission ratio) is expressed by 1+(Zs/Zi), wherein Zs is the number of teeth of the sun gear and Zi is the number of teeth of the internal gear. Therefore, as compared with a speed-reducing planetary gear mechanism that includes a fixed internal gear, an input sun gear and an output carrier, the change of the speed reducing ratio of an entirety of the speed reducer 5 and thus the change of the output speed can be made smaller, by enabling or disabling the function of the planetary gear mechanism 55. The speed reducer 5 is configured such that the speed reducing ratio in the low-speed and high-torque mode is less than 2.5 times that in the high-speed and low-torque mode.

Operation of the hedge trimmer 1B in performing a cutting operation (pruning operation, trimming operation) is basically the same as that of the hedge trimmer 1A of the first embodiment. It is noted, however, that the action modes, which respectively correspond to the two rotating directions of the motor 2, are reversed between the hedge trimmer 1A and the hedge trimmer 1B.

As described above, the speed reducer 5 of this embodiment is a planetary speed reducer that includes a single (only one) stage of the planetary gear mechanism 55. The planetary gear mechanism 55 is enabled or disabled according to the rotating direction of the motor 2 (the motor shaft 23), and accordingly, the speed reducing ratio of the speed reducer 5 and thus the output speed and output torque of the speed reducer 5 are changed. Therefore, in this embodiment, the hedge trimmer 1B can perform two actions that are different in the required output speed and output torque simply in response to the change of the rotating direction of the motor 2 without need for controlling the rotating speed of the motor 2.

In this embodiment, the speed reducer 5 can be made compact, since the speed reducer 5 includes only one planetary gear mechanism. When the function of the planetary gear mechanism 55 is disabled, the reduction gear 53 arranged between the motor shaft 23 and the internal gear 552 can provide a speed reducing function.

Correspondences between the features of the second embodiment and the features of the present disclosure are as follows. However, the features of the second embodiment are merely exemplary and do not limit the features of the present disclosure.

The hedge trimmer 1B is an example of a “power tool” and a “cutting tool”. The motor 2 and the motor shaft 23 are examples of a “motor” and a “motor shaft”, respectively. The speed reducer 5 is an example of a “speed reducer”. The speed-reducing-ratio change mechanism 6B is an example of a “speed-reducing-ratio change mechanism”. The planetary gear mechanism 55 is an example of a “planetary gear mechanism”. The one-way clutch 60 is an example of a “one-way clutch”. The second direction of the two rotating directions of the motor shaft 23 is an example of a “specific one of the two directions”. The lock mechanism 61B is an example of a “lock mechanism”. The sun gear 551 is an example of a “sun gear”. The reduction gear 53 is an example of a “reduction gear”. The bearing 511 is an example of a “first bearing”. The clutch member 601 is an example of a “clutch member”. The bearing 605 is an example of a “second bearing”. The upper blade 9 is an example of a “first blade”. The lower blade 9 is an example of a “second blade”.

The above-described embodiments are mere examples and the power too 1 according to the present disclosure is not limited to the hedge trimmers 1A, 1B of the above-described embodiments. For example, the following modifications may be made. At least one of these modifications can be employed in combination with at least one of the hedge trimmers 1A, 1B of the above-described embodiments and the claimed features.

For example, a brushed motor may be employed as the motor 2, in place of the brushless motor. The motor 2 may be driven by power supplied not from the battery 198 but from an external AC power source.

The number of the planetary gear mechanisms included in the speed reducer 4 is not limited to four, and may be any number of two or more. In the speed reducer 4, the number of the planetary gear mechanisms whose function is enabled or disabled in response to the change of the rotating direction of the motor 2 is not limited to two, but it may be three or more. The input shaft of the speed reducer 4 need not be the motor shaft 23, but another rotary shaft may be provided in a toque transmission path between the motor shaft 23 and the speed reducer 4. The speed reducer 4 need not be arranged coaxially with the motor 2. The structure of the speed reducer 5 may also be appropriately changed. For example, the speed reducer 5 may have another planetary gear mechanism or other planetary gear mechanisms in addition to the planetary gear mechanism 55.

In each of the speed-reducing-ratio change mechanisms 6A, 6B, the structures and arrangement of the one-way clutch 60 and the lock mechanism 61A, 61B may be appropriately changed. For example, the one-way clutch 60 may be of a type in which the bearings 605 are not incorporated, and a bearing or bearings may be provided separately from the one-way clutch 60. The shape, arrangement and number of each component of the lock mechanism 61A, 61B may also be appropriately changed. For example, three or more rollers 63 may be provided. The number of the projections 656 of the lock cam 65A, 65B and the number of the projections 623 of the retainer 62A, 62B may also be arbitrarily changed. The lock sleeve 64A, 64B may be omitted, and the rollers 63 may be arranged between the inner periphery of the gear housing 40, 50 and the flat surface parts 652 of the lock cam 65A, 65B such that each roller 63 is movable between the lock position and the unlock position. Further, in the speed reducer 4, the lock cam 65A and the sleeve 405 may be integrally formed as a single member. In the speed reducer 5, the lock cam 65B and the shaft 52 may be integrally formed as a single member.

The control circuit of the controller 81 may be a control circuit other than a microcomputer including a CPU. A manipulation member for inputting an instruction to change the rotating direction of the motor 2 (the motor shaft 23) is not limited to the reverse switch 855, but may be any known device. For example, a lever, a slider or a touch panel may be employed.

In the above-described embodiments, the hedge trimmers 1A, 1B are described as an example of the power tool of the present disclosure, but the present disclosure may also be applied to other power tools that selectively perform different actions according to the rotating direction of the motor.

Further, in view of the nature of the present disclosure and the above-described embodiments and their modifications, the following features are provided. At least one of the following features can be employed in combination with at least one of the above-described embodiments, their modifications and the claimed features.

### (Aspect 1)

An entirety of the at least two stages of planetary gear mechanisms is configured to function as a speed-increasing mechanism.

### (Aspect 2)

A reciprocal of a speed increasing ratio of the speed-increasing planetary gear mechanism is larger than a speed reducing ratio of the speed-reducing planetary gear mechanism.

### (Aspect 3)

The planetary gear mechanisms are arranged in at least three stages, and

the planetary gear mechanism in each stage other than the at least two stages is configured to function as a speed-reducing mechanism.

### (Aspect 4)

In Aspect 3,

the speed-increasing planetary gear mechanism and the speed-reducing planetary gear mechanism are arranged in the second stage and the third stage, respectively.

### (Aspect 5)

The one-way clutch is disposed around a shaft that is integral with the carrier of the speed-increasing planetary gear mechanism, and configured to transmit rotation to the shaft only when the motor shaft rotates in the specific one of the two directions.

The shaft 419 is an example of the “shaft”.

### (Aspect 6)

The power tool further comprises:

a control device that is configured to control operation of the power tool; and

a manipulation member that is configured to be externally manipulated by a user, wherein:

the control device is configured to change the rotating direction of the motor shaft in response to manipulation of the manipulation member by the user.

The controller 81 is an example of the “control device”.

### (Aspect 7)

The power tool further comprises:

a housing that houses the speed reducer, wherein:

the internal gears of the at least two stages are configured to selectively rotate integrally around a first axis relative to the housing,

the lock mechanism includes:
a roller that is movable between a lock position and an unlock position in a circumferential direction around the first axis,
a retainer that is configured to retain the roller to be movable between the lock position and the unlock position, and to selectively rotate integrally with the one-way clutch around the first axis relative to the housing,
a lock cam that is configured to rotate integrally with the internal gears of the at least two stages around the first axis and operably coupled to the retainer, and
a lock sleeve that is non-rotatable around the first axis relative to the housing, and that is at least partially disposed around the roller, the retainer and the lock cam,

wherein:

when the one-way clutch does not transmit rotation, the roller is held between the lock sleeve and the lock cam at the lock position and non-rotatably locks the lock cam and the internal gears of the at least two stages relative to the housing, and

when the one-way clutch transmits rotation, the roller is loosely disposed between the lock sleeve and the lock cam at the unlock position, and the retainer rotates integrally with the one-way clutch and causes the lock cam and the internal gears of the at least two stages to rotate.

The gear housing 40, 50 is an example of a “housing”. The roller 63 is an example of a “roller”. The retainer 62A, 62B is an example of a “retainer”. The lock cam 65A, 65B is an example of a “lock cam”. The lock sleeve 64A, 64B is an example of a “lock sleeve”.

### DESCRIPTION OF THE NUMERALS

1A, 1B: hedge trimmer, 11: body housing, 17: handle, 171: grip part, 19: handle, 191: grip part, 193: switch lever, 195: switch, 197: battery mounting part, 198: battery, 2: motor, 20: motor housing, 201: bearing, 202: bearing, 21: stator, 22: rotor, 23: motor shaft, 231: driving gear, 40: gear housing, 4: speed reducer, 405: sleeve, 41: first planetary gear mechanism, 411: first sun gear, 412: first internal gear, 415: first carrier, 418: first planetary gear, 419: shaft, 42: second planetary gear mechanism, 421: second sun gear, 422: second internal gear, 425: second carrier, 428: second planetary gear, 429: shaft, 43: third planetary gear mechanism, 431: third sun gear, 432: third internal gear, 435: third carrier, 438: third planetary gear, 439: shaft, 44: fourth planetary gear mechanism, 441: fourth sun gear, 442: fourth internal gear, 445: fourth carrier, 448: fourth planetary gear, 449: shaft, 451: bearing, 452: bearing, 50: gear housing, 5: speed reducer, 51: gear sleeve, 511: bearing, 52: shaft, 53: reduction gear, 55: planetary gear mechanism, 551: sun gear, 552: internal gear, 555: carrier, 558: planetary gear, 559: shaft, 571: bearing, 572: bearing, 574: bearing, 6A, 6B: speed-reducing-ratio change mechanism, 60: one-way clutch, 601: clutch member, 605: bearing, 61A, 61B: lock mechanism, 62A, 62B: retainer, 621: base part, 623: projection, 625: cylindrical part, 627: sleeve part, 63: roller, 64A, 64B: lock sleeve, 65A, 65B: lock cam, 651: tubular part, 652: flat surface part, 656: projection, 70: crank housing, 7: motion converting mechanism, 71A: lock mechanism, 72: cam plate, 721: eccentric part, 722: eccentric part, 731: connecting rod, 81: controller, 85: manipulation part, 851: main power switch, 855: reverse switch, 87: display part, 50: blade, 90: cutting teeth, 97: blade guide

What is claimed is:

1. A power tool, comprising:
a motor having a motor shaft that is rotatable in two directions opposite to each other;
a speed reducer that is operably coupled to the motor shaft and that includes planetary gear mechanisms arranged in multiple stages; and
a speed-reducing-ratio change mechanism that is configured to change a speed reducing ratio of the speed reducer in response to a change of a rotating direction of the motor shaft,
wherein:
at least two stages of the planetary gear mechanisms are configured such that an internal gear in each stage selectively functions as a fixed element, and
the speed-reducing-ratio change mechanism includes:
a one-way clutch that is in a torque transmission path, and that is configured to transmit rotation only when the motor shaft rotates in specific one of the two directions, and
a lock mechanism that is operably coupled to the one-way clutch and to the internal gears of the at least two stages of the planetary gear mechanisms, and that is configured to non-rotatably lock the internal gears of the at least two stages when the one-way clutch does not transmit rotation, and to rotate the internal gears of the at least two stages when the one-way clutch transmits rotation, and
the at least two stages of the planetary gear mechanisms include:
a speed-increasing planetary gear mechanism configured to function as a speed-increasing mechanism; and
a speed-reducing planetary gear mechanism configured to function as a speed-reducing mechanism.

2. The power tool as defined in claim 1, wherein the speed-increasing planetary gear mechanism is in a former stage of the speed-reducing planetary gear mechanism.

3. The power tool as defined in claim 2, wherein a sun gear of the speed-increasing planetary gear mechanism that functions as an output element of the speed reducer and a sun gear of the speed-reducing planetary gear mechanism that functions as an input element form a single member in the speed reducer.

4. The power tool as defined in claim 1, wherein an entirety of the at least two stages of planetary gear mechanisms is configured to function as a speed-increasing mechanism.

5. The power tool as defined in claim 4, wherein:
the planetary gear mechanisms are arranged in at least three stages, and
the planetary gear mechanism in each stage other than the at least two stages is configured to function as a speed-reducing mechanism.

6. The power tool as defined in claim 1, wherein the speed reducer is configured to operate in a high-speed and low-torque mode when the lock mechanism non-rotatably locks the internal gears of the at least two stages, and to operate in a low-speed and high-torque mode when the lock mechanism rotates the internal gears of the at least two stages.

7. The power tool as defined in claim 1, wherein the one-way clutch includes a clutch member and second bearings disposed on opposite sides of the clutch member in an axial direction of the one-way clutch.

8. The power tool as defined in claim 1, wherein a speed reducing ratio of the speed reducer when the motor shaft rotates in one of the two directions is less than 2.5 times the speed reducing ratio of the speed reducer when the motor shaft rotates in the other of the two directions.

9. The power tool as defined in claim 1, wherein:
the power tool is a cutting tool that includes a body to which a first blade and a second blade are removably attachable, and that is configured to linearly reciprocate the first blade and the second blade relative to each other, and thereby cut an object in a forward stroke in which the first blade moves forward relative to the second blade and a backward stroke in which the first blade moves backward relative to the second blade.

10. The power tool as defined in claim 1, further comprising:
a housing that houses the speed reducer,
wherein:
the internal gears of the at least two stages are configured to selectively rotate integrally around a first axis relative to the housing,
the lock mechanism includes:
a roller that is movable between a lock position and an unlock position in a circumferential direction around the first axis;
a retainer that is configured to retain the roller to be movable between the lock position and the unlock position, and to selectively rotate integrally with the one-way clutch around the first axis relative to the housing;
a lock cam that is configured to rotate integrally with the internal gears of the at least two stages around the first axis and operably coupled to the retainer; and
a lock sleeve that is non-rotatable around the first axis relative to the housing, and that is at least partially disposed around the roller, the retainer and the lock cam,
when the one-way clutch does not transmit rotation, the roller is held between the lock sleeve and the lock cam at the lock position and non-rotatably locks the lock cam and the internal gears of the at least two stages relative to the housing, and
when the one-way clutch transmits rotation, the roller is loosely disposed between the lock sleeve and the lock cam at the unlock position, and the retainer rotates integrally with the one-way clutch and causes the lock cam and the internal gears of the at least two stages to rotate.

11. A power tool, comprising:
a motor having a motor shaft that is rotatable in two directions opposite to each other;
a speed reducer that is operably coupled to the motor shaft and that includes a planetary gear mechanism; and
a speed-reducing-ratio change mechanism that is configured to change a speed reducing ratio of the speed reducer in response to a change of a rotating direction of the motor shaft,
wherein:
the planetary gear mechanism is configured such that a sun gear of the planetary gear mechanism selectively functions as a fixed element, and an internal gear of the planetary gear mechanism functions as an input element, and
the speed-reducing-ratio change mechanism includes:
a one-way clutch that is in a torque transmission path, and that is configured to transmit rotation only when the motor shaft rotates in specific one of the two directions, and
a lock mechanism that is operably coupled to the one-way clutch and to the sun gear, and that is configured to non-rotatably lock the sun gear when the one-way clutch does not transmit rotation, and to rotate the sun gear when the one-way clutch transmits rotation.

12. The power tool as defined in claim 11, further comprising a reduction gear that is between the motor shaft and the internal gear of the planetary gear mechanism in the torque transmission path.

13. The power tool as defined in claim 11, wherein the speed reducer includes only one stage of the planetary gear mechanism.

14. The power tool as defined in claim 11, wherein the internal gear is rotatably supported by a first bearing.

15. The power tool as defined in claim 11, wherein the one-way clutch includes a clutch member and second bearings disposed on opposite sides of the clutch member in an axial direction of the one-way clutch.

16. The power tool as defined in claim 11, wherein a speed reducing ratio of the speed reducer when the motor shaft rotates in one of the two directions is less than 2.5 times the speed reducing ratio of the speed reducer when the motor shaft rotates in the other of the two directions.

17. The power tool as defined in claim 11, wherein:
the power tool is a cutting tool that includes a body to which a first blade and a second blade are removably attachable, and that is configured to linearly reciprocate the first blade and the second blade relative to each other, and thereby cut an object in a forward stroke in which the first blade moves forward relative to the second blade and a backward stroke in which the first blade moves backward relative to the second blade.
